(19) United States
(12) Patent Application Publication
(10) Pub. No.: US 2013/0229722 A1
(43) Pub. Date: Sep. 5, 2013

(54) HIGH THROUGHPUT REFLECTING MICROSCOPE OBJECTIVE

(71) Applicant: Steven Vogel, Shelton, CT (US)

(72) Inventor: Steven Vogel, Shelton, CT (US)

(21) Appl. No.: 13/769,752

(22) Filed: Feb. 18, 2013

Related U.S. Application Data
(60) Provisional application No. 61/606,151, filed on Mar. 2, 2012.

(51) Int. Cl. G02B 21/04

(52) U.S. Cl. CPC G02B 21/04
USPC 359/858

(57) ABSTRACT

Methods, systems, and apparatuses for objectives are provided. An objective includes a body, a first concave mirrored surface on the body, a second concave mirrored surface on the body, and a central pathway. The first concave mirrored surface has a centrally located first opening. The second concave mirrored surface has a centrally located second opening. The first and second concave mirrored surfaces are oriented in opposition to each other and coupled together at the first and second openings. The central pathway extends from a first end of the body to a second end of the body, and an axis of symmetry of the body resides in the central pathway. The first and second concave mirrored surfaces focus/magnify light passing through the central pathway through the body. The objective may also include a mask that at least partially obscures the light passing through the central pathway through the body.

This application claims the benefit of U.S. Provisional Application No. 61/606,151, filed on Mar. 2, 2012, which is incorporated by reference herein in its entirety.

### BACKGROUND OF THE INVENTION

1. Field of the Invention

The present invention relates to microscope objectives.

2. Background Art

In optics, various optical systems may be used to modify the behavior of light. Such optical systems have optical aberration parameters, including the coma, which is a change in magnification with position on an aperture stop, and the spherical, which is a change in the path length taken by a light ray to the focus for different positions on the aperture stop. In an aplanatic system, the coma and spherical are both zero. Aplanatic systems may be used in various types of optical devices, such as telescopes.

In 1905, Karl Schwarzschild published several papers on geometrical optics that dealt with the aberrations encountered in optical systems. In a first paper, Schwarzschild showed how spherical aberrations originate. In a second paper, Schwarzschild demonstrated how a telescope free of aberrations can be formed by combining two mirrors with aspherical surfaces. In a third paper he provided formulas for computing a variety of compound optical systems.

In 2005, V. Yu Terebizh published a paper that examined Schwarzschild's second paper regarding aplanatic telescopes. In his paper, Terebizh indicated that Schwarzschild's equations held true for arbitrary two-mirror aplanatic systems. These parametric equations from Schwarzschild are commonly approximated by spherical surfaces, which are traditionally easier to manufacture than aspherical surfaces. These approximations, however, are only accurate at smaller aperture sizes and do not maintain the aplanatic condition as accurately as the parametric equations. They suffer from small input aperture diameters because the approximations that they rely on fall apart at larger aperture sizes. They also have relatively large outer diameters relative to the entrance pupil diameter.

### BRIEF SUMMARY OF THE INVENTION

Systems, methods, and apparatuses are described for objectives used in optical systems, substantially as shown in and/or described in connection with at least one of the figures, as set forth more completely in the claims.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 illustrates a reflective microscope mirror configuration defining first and second curves that may be used in embodiments.

FIGS. 2 and 3 show the first and second curves of FIG. 1, according to example embodiments.

FIG. 4 shows a cross-sectional view of a single-piece objective that contains two powered mirror surfaces defined by equations, according to an example embodiment.

FIG. 5 shows a perspective view of the objective of FIG. 4, and further shows a position of a mask when a single mask is used, according to an example embodiment.

FIG. 6A shows a perspective view of a mask with two spider arms, according to an example embodiment.

FIG. 6B shows a perspective view of a mask with three spider arms, according to an example embodiment.

FIG. 6C shows a perspective view of a mask with a substantially optically clear material used to support a substantially opaque mask, according to an example embodiment.

FIG. 7 shows a cross-sectional view of an objective without a mask allowing a stray light ray to pass through and reflect back, according to an example embodiment.

FIG. 8 shows a cross-sectional view of the stray light ray of FIG. 7 blocked by a mask, according to an example embodiment.

FIG. 9 shows a cross-sectional view of an objective including a single mask, according to an example embodiment.

FIG. 10 shows an exploded view of an objective that uses the powered surfaces shown in FIG. 4, and includes a mechanism for adjusting spacing between the two surfaces, according to an example embodiment.

FIG. 11 shows a cut away perspective view of an objective that includes a mechanism for adjusting a spacing between two powered surfaces, according to an example embodiment.

FIG. 12 shows a cut away perspective view of an objective that uses a two-element mask of a first type, according to an example embodiment.

FIG. 13 shows a cross-sectional view of the objective of FIG. 12 including the two-element mask of the first type, according to an example embodiment.

FIG. 14 shows a cut away perspective view of an objective that uses a two-element mask of a second type, according to an example embodiment.

FIG. 15 shows a cross-sectional view of the objective of FIG. 14 including the two-element mask of the second type, and showing light rays, according to an example embodiment.

FIG. 16 shows a cross-sectional view of an objective that uses a single element mask of a third type, according to an example embodiment.

FIG. 17 shows a side cross-sectional view of a solid optically clear objective, according to an example embodiment.

FIG. 18 shows a side cross-sectional view of the objective of FIG. 17, with a mask and with light rays traveling through the objective, according to an example embodiment.

FIG. 19 shows a side cross-sectional view of an optically clear two-piece objective, with a mask and with light rays traveling through the objective, according to an example embodiment.

FIGS. 20A-20C show examples of equations that may be used in embodiments to define first and second concave mirror surfaces.

The present invention will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION OF THE INVENTION

### Introduction

The present specification discloses one or more embodiments that incorporate the features of the invention. The disclosed embodiment(s) merely exemplify the invention. The scope of the invention is not limited to the disclosed embodiment(s). The invention is defined by the claims appended hereto.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described herein.

Furthermore, it should be understood that spatial descriptions (e.g. “above”, “below”, “up”, “down”, “left”, “right”, “top”, “bottom”, “vertical”, and “horizontal”, etc) used herein are for purposes of illustration only, and that practical implementations of the structures described herein can be spatially arranged in any orientation or manner.

### EXAMPLE EMBODIMENTS

The example embodiments described herein are provided for illustrative purposes, and are not limiting. Furthermore, their structural and operational embodiments, including modifications, alterations, will become apparent to persons skilled in the relevant art(s) from the teachings herein.

An objective is an optical element that gathers light from an object being observed, and focuses the light to form an image. Embodiments are disclosed herein for objectives that may be used in optical systems, such as microscopes and telescopes. In an embodiment, a larger aperture, aplanatic reflective objective is provided that is smaller in overall diameter and cheaper to produce than the tradition Schwarzschild design at the same magnification.

An aplanatic system is one where the optical aberrations of spherical and coma are both zero. In V. Yu Terebizh's 2005 paper, “Two-Mirror Schwarzschild Aplanats. Basic Relations,” Astronomy Letters 31, 129-139, Terebizh examined Karl Schwarzschild's 1905 paper regarding aplanatic telescopes. Terebizh indicated that Schwarzschild's equations held true for arbitrary two-mirror aplanatic systems. A Gregorian mirror configuration includes two concave surfaces with an intermediate focus formed between them. Both concave surfaces are positioned between their individual vertexes and the intersection of the two curves. One of the two mirrored surfaces in a Gregorian configuration contains a hole which the light passes through. In embodiments, the mirror surfaces for a Gregorian system are extended beyond the intersection of the two generated reflecting curves, and the resulting larger surface is used to provide a larger input aperture to a microscope objective. In an embodiment, an objective is configured in a shape similar to that of an hourglass (e.g., the shape of two bowls placed bottom to bottom with their centers cut out to let the light pass through). In such an embodiment, the two concave surfaces have openings in their middle areas, and are joined together at the openings, such that the two concave surfaces face away from each other (as opposed to a typical Gregorian system, where the light passes through a hole in only one of the two concave surfaces).

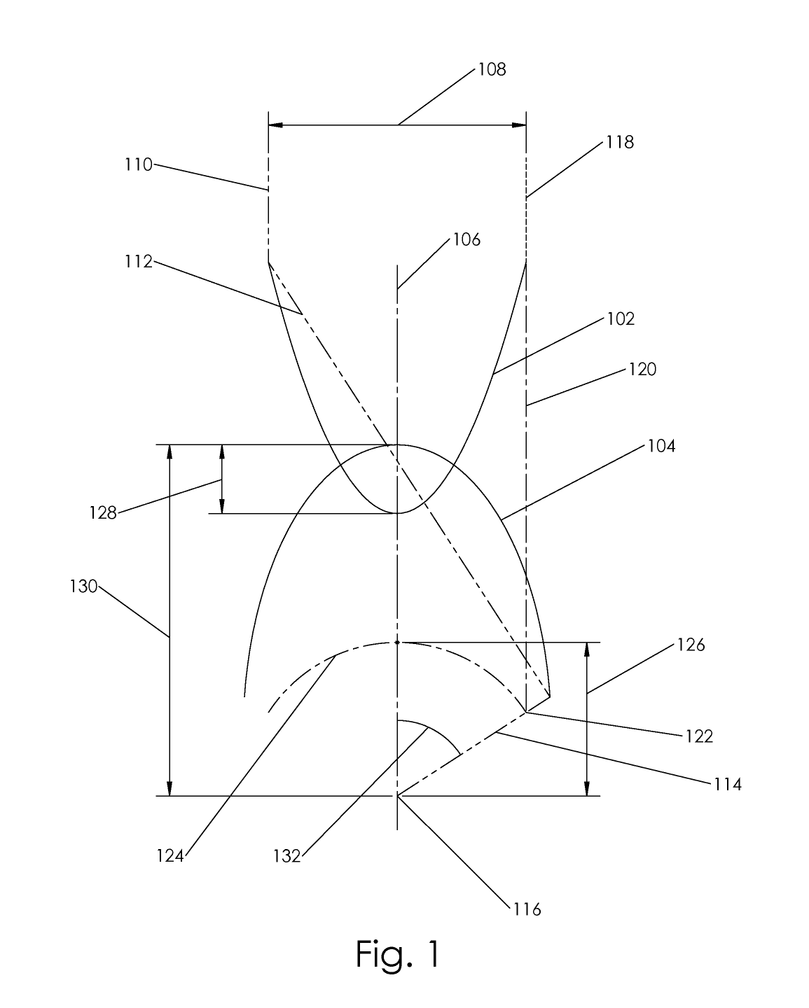

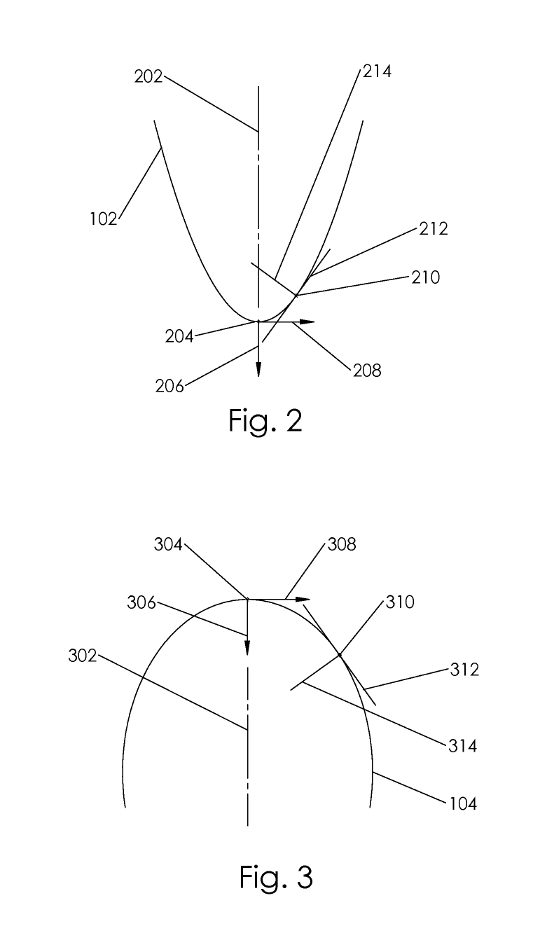

FIG. 1 illustrates a configuration of concave mirror surfaces that may be used in embodiments. As shown in FIG. 1, the surface configuration includes first and second optical surfaces indicated as first and second concave mirrored surfaces 102 and 104. In embodiments, first and second optical surfaces (e.g., curved mirrored surfaces) of an objective may be aligned similarly to first and second concave mirrored surfaces 102 and 104 in an objective to focus (e.g., magnify) light passing through. FIGS. 2 and 3 show first and second concave mirrored surfaces 102 and 104 individually. FIGS. 1-3 are described as follows to illustrate features of the surface configuration and of first and second optical surfaces 102 and 104.

In FIG. 1, concave mirrored surface 102 defines a first concave mirrored surface, and concave mirrored surface 104 defines a second concave mirrored surface. Concave mirrored surfaces 102 and 104 are each concave shapes (e.g., bowl shaped) and are each symmetrical around an axis 106. Axis 106 is an axis of rotational symmetry that passes through the vertexes of each of concave mirrored surfaces 102 and 104. First diameter 108 is a diameter of the first concave mirrored surface 102. As shown in FIG. 1, concave mirrored surfaces 102 and 104 are arranged in an hourglass shape.

Input light ray 110 is a collimated input ray received at an outermost edge of first concave mirrored surface 102. Input light ray 112 is input light ray 110 after reflecting off of the outermost edge of first concave mirrored surface 102 towards the center of first concave mirrored surface 102, through an opening (not shown in FIG. 1) in the centers of first and second concave mirrored surfaces 102 and 104, onto an outermost edge of second concave mirrored surface 104. Input light ray 114 is input light ray 112 after reflecting off of the outermost edge of second concave mirrored surface 104 to a focus point 116. Focus point 116 is a common light ray focus point at an image plane for the surface configuration of FIG. 1. The image plane is located outside of the concave shape of second concave mirrored surface 104.

Collimated input light ray 118 is a collimated input light ray received at an edge of first concave mirrored surface 102. Collimated input light ray 118 is symmetric to input light ray 110 about axis 106. Line 120 is a line that is colinear with collimated input light ray 118, and intersects with input light ray 114. Intersection point 122 is a point of intersection of line 120 and input light ray 114. Circle 124 is a circle symmetric around axis 106 that defines the effective focal length 126, F, having a center at focus point 116. Delta 128 is a distance between the vertex of first concave mirrored surface 102 and the vertex of second concave mirrored surfaces 104. As shown in FIG. 1, the curves of first and second concave mirrored surfaces 102 and 104 overlap with each other, such that the vertex of first concave mirrored surface 102 is located within the concave shape of second concave mirrored surface 104, and the vertex of second concave mirrored surface 104 is located within the concave shape of first concave mirrored surface 102. Back focal length 130, B, is the back focal length or distance from the vertex of second concave mirrored surface 104 (point of second concave mirror surface 104 that intersects axis 106 in FIG. 1) to focus point 116. Angle 132, U, is the angle between axis 106 and input light ray 114 after reflecting off of second concave mirrored surface 104.

Referring to FIG. 2, an axis 202 is shown that is an axis of rotational symmetry for first concave mirrored surface 102 (which is colinear with axis 106 in FIG. 1). Vertex 204 is a vertex of first concave mirrored surface 102 (a center of, and a point of maximum curvature of first concave mirrored surface 102). Axis 206 is an axis defining a first concave mirrored surface direction S1 (e.g., a normal direction to first concave mirrored surface 102 at vertex 204 and collinear with axis 106 in FIG. 1). Axis 208 is an axis defining first concave mirrored surface direction Y1 (e.g., a direction perpendicular to axis 206 from vertex 204, and tangent to first concave mirrored surface 102). Point 210 is a point on first concave mirrored surface 204. Tangent line 212 is a line tangent to first concave mirrored surface 102 at point 210. Normal line 214 is a line normal to first concave mirrored surface 102 at point 210, directed inward from point 210.

Referring to FIG. 3, an axis 302 is shown that is an axis of rotational symmetry for second concave mirrored surface 104 (which is colinear with axis 106 in FIG. 1). Vertex 304 is a vertex of second concave mirrored surface 104 (a center of, and a point of maximum curvature of second concave mirrored surface 104). Axis 306 is an axis defining second concave mirrored surface direction S2 (e.g., a normal direction to second concave mirrored surface 104 at vertex 304 and collinear with axis 106 in FIG. 1). Axis 308 is an axis defining second concave mirrored surface direction Y2 (e.g., a direction perpendicular to axis 306 from vertex 304, and tangent to second concave mirrored surface 104 at vertex 304). Point 310 is a point on second concave mirrored surface 104. Tangent line 312 is a line tangent to second concave mirrored surface 104 at point 310. Normal line 314 is a line normal to second concave mirrored surface 104 at point 310.

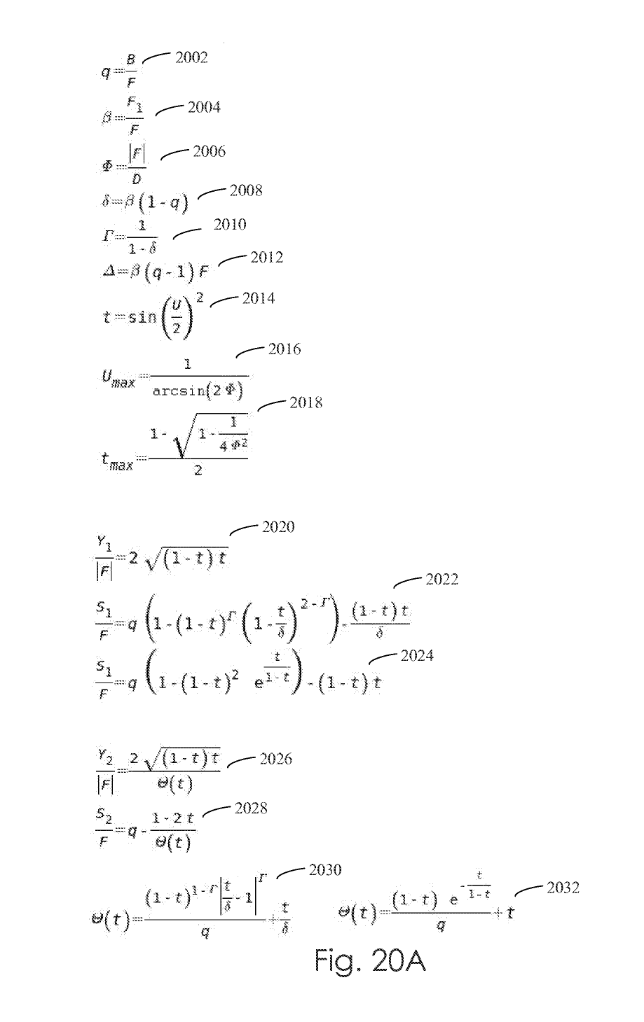

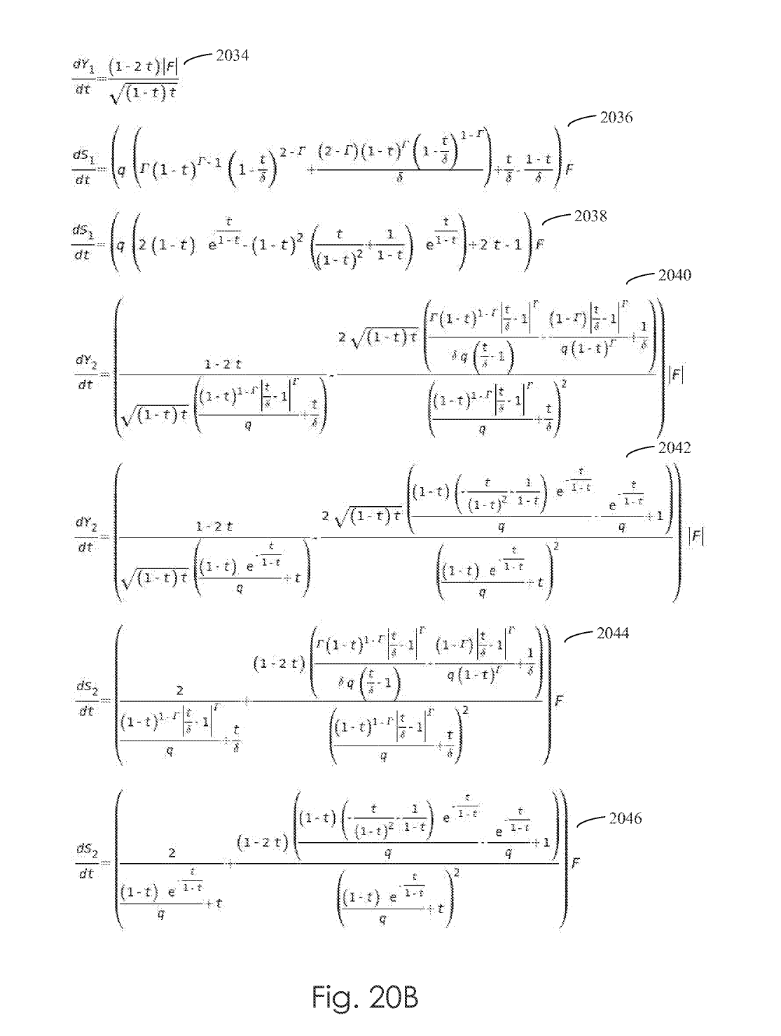

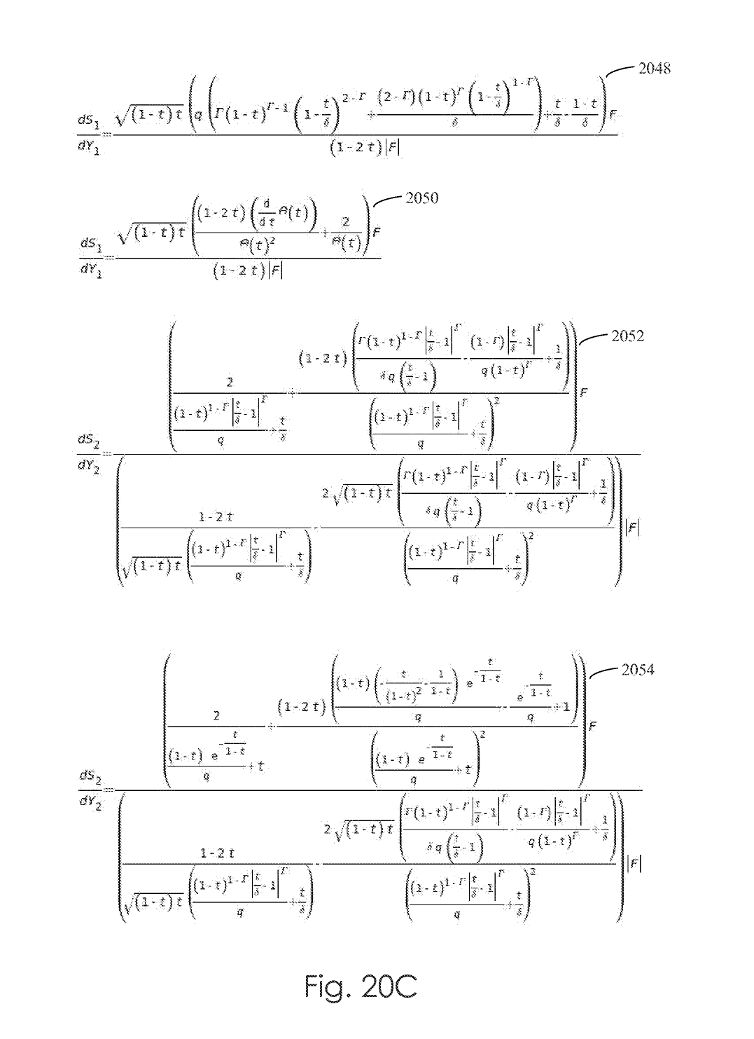

Concave mirrored surfaces 102 and 104 may be used in objectives in the surface configuration of FIG. 1 in embodiments. Examples of such embodiments are described further below. In an embodiment, the curved shapes of concave mirrored surfaces 102 and 104 may be defined by equations. In an embodiment, the surface equations used to meet the aplanatic condition can be written in a parametric from using the parameter t=sin² (U/2), where U is the angle a light ray makes with the optical axis (e.g., axis 106 of FIG. 1) at the focus (e.g., focus point 116 of FIG. 1). Examples of equations that may be used in embodiments are shown in FIGS. 20A-20C. FIG. 20A includes equations 2002-2032, FIG. 20B includes equations 2034-2046, and FIG. 20C includes equations 2048-2054. Equations 2002-2054 are described as follows with reference to FIGS. 1-3. The terms used in equations 2002-2054 are described with respect to the first equation in which they appear.

Equations 2002-2018 are used to calculate various parameters. It is noted that delta Δ is the distance between vertices of concave mirrored surfaces 102 and 104.

With reference to equation 2002, F is effective focal length 126, and B is back focal length 130.

With reference to equation 2004, F1 is the focal length of first concave mirror surface 102 (not shown in FIG. 1).

With reference to equation 2006, D is the input aperture diameter, which is first diameter 108 (the maximum diameter of first concave mirror surface 102).

With reference to equation 2014, U is the angle between axis 106 and input light ray 114 reflecting off of second concave mirrored surface 104 to focus point 116. U may have values that range from 0 degrees to 90 degrees. For instance, U may be incremented by a predetermined amount from 0 degrees to 90 degrees (e.g., in increments of 1 degree, a portion of 1 degree, etc.) to determine values for t in Equation 2014.

Equations 2020, 2022, and 2024 are used to calculate the locations of points of first concave mirrored surface 102 based on a range of values for t (Equation 2024 is used instead of Equation 2022 for values of δ=1, because in such case, Γ of Equation 2010 would be otherwise be infinity). Y1 is a lateral distance for a point on concave mirrored surface 102 from axis 106, and may be calculated by Equation 2020. S1 is a distance from the axis 208 to the point resolved in the direction of axis 206, and may be calculated by Equation 2022 or Equation 2024. As such, a calculated point resides on concave mirrored surface 102 at the intersection of the distance Y1 from axis 106 and the distance S1 from the axis 208. A pair of points on either side of axis 106 may be determined for concave mirror surface 102 in this manner (e.g., an first intersection of a first line at distance Y1 on a first side of axis 106 with a second line defined by the perpendicular distance from axis 208 determined by S1, and a second intersection of a third line at distance Y1 on a second side of axis 106 with a line defined by the perpendicular distance from axis 208 determined by S1).

Equations 2026 and 2028 are used to calculate the locations of points of second concave mirrored surface 104 based on a range of values for t. Y2 is a lateral distance for a point on concave mirrored surface 104 from axis 106, and may be calculated by Equation 2026. S2 is a distance from the axis 308 to the point resolved in the direction of axis 306, and may be calculated by Equation 2028. As such, a calculated point resides on concave mirrored surface 104 at the intersection of the distance Y2 from axis 106 and the distance S2 from axis 308. A pair of points on either side of axis 106 may be determined for concave mirror surface 104 in this manner (e.g., an first intersection of a first line at distance Y2 on a first side of axis 106 with a second line defined by the perpendicular distance from axis 308 determined by S2, and a second intersection of a second line at distance Y2 on a second side of axis 106 with a line defined by the perpendicular distance from axis 208 determined by S2).

Equations 2030 and 2032 are used to calculate values of the variable θ used in Equations 2026 and 2028.

Equation 2034 is used to calculate a first derivative of Y1 with respect to t.

Equation 2036 is used to calculate a first derivative of S1 with respect to t (when δ≠1).

Equation 2038 is used to calculate a first derivative of S1 with respect to t (when δ=1).

Equation 2040 is used to calculate a first derivative of Y2 with respect to t (when δ≠1).

Equation 2042 is used to calculate a first derivative of Y2 with respect to t (when δ=1).

Equation 2044 is used to calculate a first derivative of S2 with respect to t (when δ≠1).

Equation 2046 is used to calculate a first derivative of S2 with respect to t (when δ=1).

Equation 2048 is used to calculate a first derivative of S1 with respect to Y1 (when δ≠1). For instance, Equation 2048 may determine a slope of tangent line 212 on first concave mirror surface 102 at the point Y1, S1.

Equation 2050 is used to calculate a first derivative of S1 with respect to Y1 (when δ=1). For instance, Equation 2050 may determine a slope of tangent line 212 on first concave mirror surface 102 at the point Y1, S1.

Equation 2052 is used to calculate a first derivative of S2 with respect to Y2 (when δ≠1). For instance, Equation 2052 may determine a slope of tangent line 312 on second concave mirror surface 104 at the point Y2, S2.

Equation 2054 is used to calculate a first derivative of S2 with respect to Y2 (when δ=1). For instance, Equation 2054 may determine a slope of tangent line 312 on second concave mirror surface 104 at the point Y2, S2.

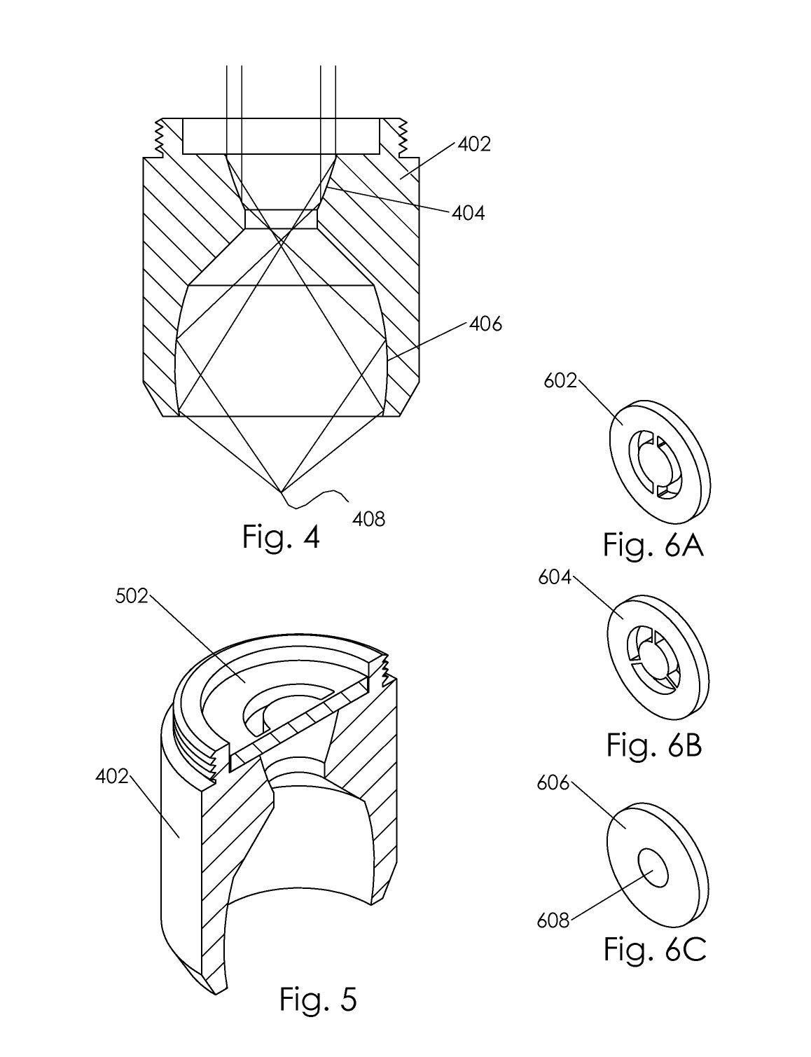

FIGS. 4-19 show various embodiments related to objectives configured according to embodiments. For instance, embodiments of objectives described as follows may include first and second concave mirrored surfaces that are shaped and function as described above with respect to FIGS. 1-3 and one or more of Equations 2002-2054 of FIGS. 20A-20C. For instance, Equations 2020 and 2022 or 2204 may be used to calculate the locations of a plurality of points to define first concave mirrored surface 102, and Equations 2026 and 2028 may be used to calculate the locations of a plurality of points to define second concave mirrored surface 104. Examples of such embodiments are described as follows.

For instance, FIG. 4 shows a cross-sectional view of a single-piece objective that includes first and second concave mirror surfaces 404 and 406, according to an example embodiment. First and second concave mirror surfaces 404 and 406 are examples of first and second concave mirror surfaces 102 and 104 of FIGS. 1-3. First and second concave mirror surfaces 404 and 406 may be shaped according to the equations described above. For instance, first concave mirror surface 404 may be defined as a collection of points calculated according to Equations 2020, 2022, and 2204, and second concave mirror surface 406 may be defined as a collection of points calculated according to Equations 2026 and 2028. The objective of FIG. 4 is described as follows.

As shown in FIG. 4, the objective includes a body 402 and first and second concave mirrored surfaces 404 and 406. First concave mirrored surface 404 is formed on body 402, and has a centrally located first opening (at the bottom portion of concave mirrored surface 404 in FIG. 4). Second concave mirrored surface 406 is formed on body 402, and has a centrally located second opening (at the top portion of concave mirrored surface 404 in FIG. 4). As shown in FIG. 4, first and second concave mirrored surfaces 404 and 406 are oriented in opposition to each other—e.g., are concave facing away from each other (e.g., their respective “bowls” face away from each other). First and second concave mirrored surfaces 404 and 406 are coupled together at the first and second openings. For instance, in the embodiment of FIG. 4, there is a cylindrical channel and a cone shaped channel (flaring outward towards second concave mirrored surface 406) that connect the first opening of first concave mirrored surface 404 to the second opening of second concave mirrored surface 406.

Furthermore, as shown in FIG. 4, a central pathway extending from a first end of body 402 (a top end of body 402 in FIG. 4) opposite first concave mirrored surface 404 to a second end of body 402 (a bottom end of body 402 in FIG. 4) opposite second concave mirrored surface 406. An axis of symmetry of body 402 resides in the central pathway, similar to axis 106 shown in FIG. 6.

First concave mirrored surface 404 and second concave mirrored surface 406 focus light passing through the central pathway through body 402. For instance, in the case where collimated input light is received at the first end (e.g., top) of body 402, the light passes through body 402 to be focused by first and second concave mirrored surfaces 404 and 406 at a focal point 408 (e.g., focus point 116 in FIG. 1) beyond the second end (e.g., bottom) of body 402. In another embodiment, input light may emanate from focal point 408 outside of the second end (e.g., bottom) of body 402 to be received at the second end of body 402. The input light passes through body 402 to be collimated (e.g., magnified) by first and second concave mirrored surfaces 404 and 406, and to be transmitted from the first end (e.g., top) of body 402 as collimated output light.

The objective of FIG. 4 may be manufactured in various ways, in embodiments. For instance, the body of the objective of FIG. 4 may be manufactured by being machined from a material, by being cast in a mold, by being stamped from a material, etc. Examples of materials included in body 402 of the objective of FIG. 4 include one or more metals (e.g., an alloy) such as iron, steel (e.g., stainless steel, spring steel), sheet metal, aluminum, copper, brass, glass, a polymer, etc. First and second concave mirror surfaces 404 and 406 may be formed on body 402 in any manner (e.g., vacuum deposition, polishing, plating, etc.), and may be made from any suitable material (e.g., silver, aluminum, gold, dielectric coating, etc.). For instance, in an embodiment, body 402 may have surfaces shaped according to the equations described above, and first and second concave mirror surfaces 404 and 406 may be formed on the shaped surfaces of body 402 to be shaped according to the equations described above.

In an embodiment, a mask may be present that at least partially obscures the light passing through the central pathway through body 402. For instance, FIG. 5 shows a perspective view of the objective of FIG. 4, and further shows a position of a mask 502 in the objective, according to an example embodiment. In the example of FIG. 5, mask 502 is a single piece mask, and is positioned at the first end of body 402. Mask 502 is positioned inside a cylindrical portion of body 402 extending from the first end of body 402. In the embodiment of FIG. 5, the cylindrical portion has smooth inner walls, and is threaded around its perimeter (e.g., to enable the objective to be screwed into a mating optical system component). Mask 502 includes a central obscuration that blocks light from passing through a center of mask 502, providing the masking function, while enabling light to pass through mask 502 around the central obscuration. An obscuration is an element (e.g., a disk or other shape) that is opaque, and therefore blocks the transmission of light.

Mask 502 may be configured in various ways, in embodiments. For instance, FIGS. 6A-6C show example embodiments for mask 502, which are described as follows. In other embodiments, mask 502 may be configured in other ways.

FIG. 6A shows a perspective view of a mask 602 with two arms, according to an example embodiment. As shown in FIG. 6A, mask 602 is a single-piece mask, and includes a circular central obscuration (e.g., an opaque disk), a ring shaped portion that is separate from and rings the central obscuration, and first and second arms connected between the ring shaped portion and the central obscuration. The first and second arms, which are positioned on opposite sides of the central obscuration, hold the central obscuration in the central position within the ring-shaped portion. Furthermore, the first and second arms enable light to pass through mask 602 between the ring shaped portion and the central obscuration, while the central obscuration blocks light from passing through a center of mask 602, providing the masking function.

Any number of arms (e.g., “support arms”, “spider arms”, etc.) may be included in a mask similar to mask 602 to support a central obscuration. For instance, FIG. 6B shows a perspective view of a mask 604 that includes first-third arms, according to an example embodiment. As shown in FIG. 6B, the first-third arms are connected between the ring shaped portion and the central obscuration. In the example of FIG. 6B, the first-third arms are spaced 120 degrees apart from each other around the central obscuration, and hold the central obscuration in the central position within the ring-shaped portion.

FIG. 6C shows a perspective view of a mask 606 that has no arms, according to an example embodiment. As shown in FIG. 6C, mask 606 includes a central obscuration 608 and a substantially optically clear ring shaped portion that rings and supports central obscuration 608. The optically clear ring shaped portion fulfills the functions of the ring-shaped portion and arms of FIGS. 6A and 6B, holding central obscuration 608 in the central position. Furthermore, the optically clear ring shaped portion enables light to pass through itself, around central obscuration 608, while central obscuration 608 blocks light from passing through a center of mask 606, providing the masking function.

The optically clear ring shaped portion of mask 606 may be made from a variety of optically clear/transparent materials, including glass, a clear polymer, a crystal, etc. Central obscuration 608 of mask 606, mask 602, mask 604, and mask 502 may each may be made from a variety of opaque materials, including one or more metals (e.g., an alloy) such as iron, steel (e.g., stainless steel, spring steel), sheet metal, aluminum, copper, brass, glass, a polymer, etc.

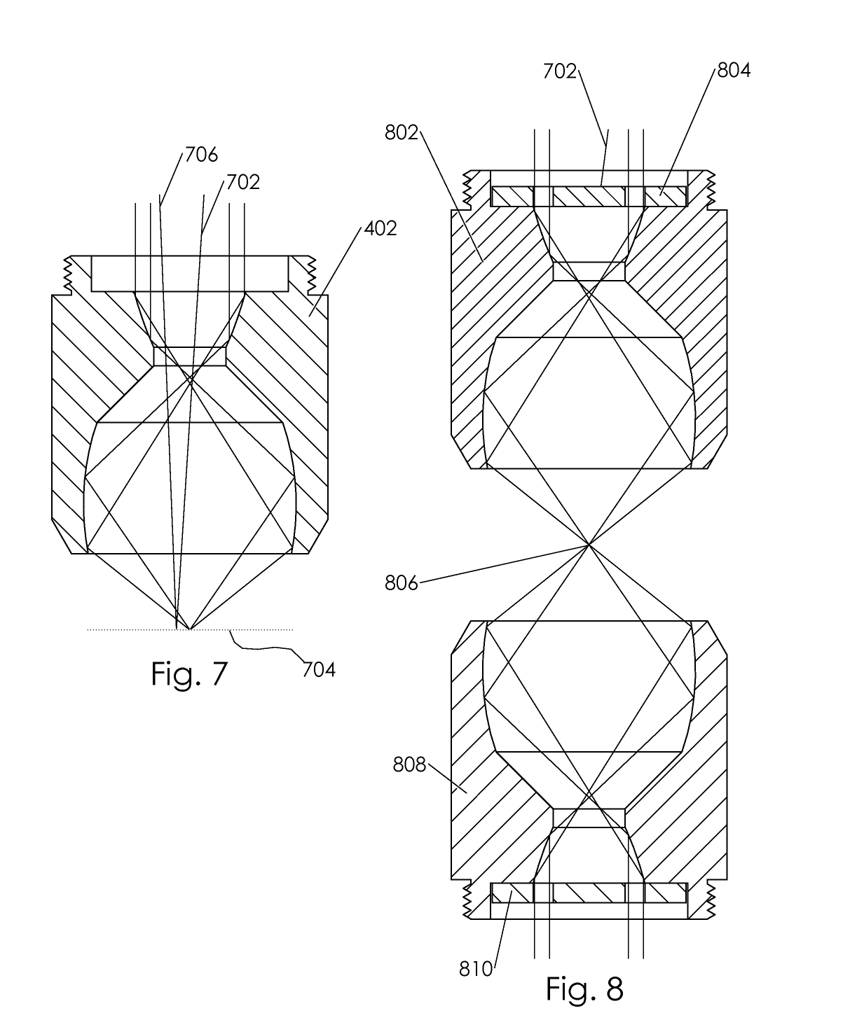

The presence of a mask in the objective of FIGS. 4 and 5 enables stray light rays to be prevented from passing through the objective, because such stray light rays can cause poor quality images. For instance, FIG. 7 shows a cross-sectional view of the objective of FIG. 4 with no mask present, according to an example embodiment. As shown in FIG. 7, a stray light ray 702 is enabled to be received by and pass through the objective to hit a reflective sample surface 704 and be reflected back through the objective as a stray light ray 706. Stray light ray 702 is an off-axis light ray (a light ray that is not parallel to the axis of symmetry of the objective) that does not interact with first concave mirrored surface 404. Such stray light rays are undesirable.

FIG. 8 shows a cross-sectional view of the objective of FIG. 7 with a mask 804 present such that stray light ray 702 is blocked by mask 804, according to an example embodiment. In the example of FIG. 8, mask 804 is one of mask 602 (FIG. 6A) or 604 (FIG. 6B). As shown in FIG. 8, the central obscuration of mask 804 blocks light ray 702 from entering the objective. Other light rays that pass between the central obscuration and the ring shaped portion (and that are not blocked by a support arm) are enabled to pass through the objective as described above, to be focused at a focal point 806.

In the example of FIG. 8, a second objective having a body 808 and a mask 810 is present, for illustrative purposes. The second objective is configured the same as the first objective, has mask 810 positioned similarly to mask 804 in the first objective, is oppositely oriented to the first objective, and is spaced relative to the first objective to have the same focal point 806. As such, the second end of body 808 of the second objective receives the light that passes through the first objective and through focal point 806. The received light passes through the second objective, and is converted into collimated light by first and second concave mirrored surfaces of the second objective. The collimated light is transmitted out of the first end of body 808 of the second objective.

Thus, the two-objective configuration of FIG. 8 may be used to filter received light by masking and focusing input collimated light, and re-collimating with a first objective, and masking and re-collimating the masked and focused light.

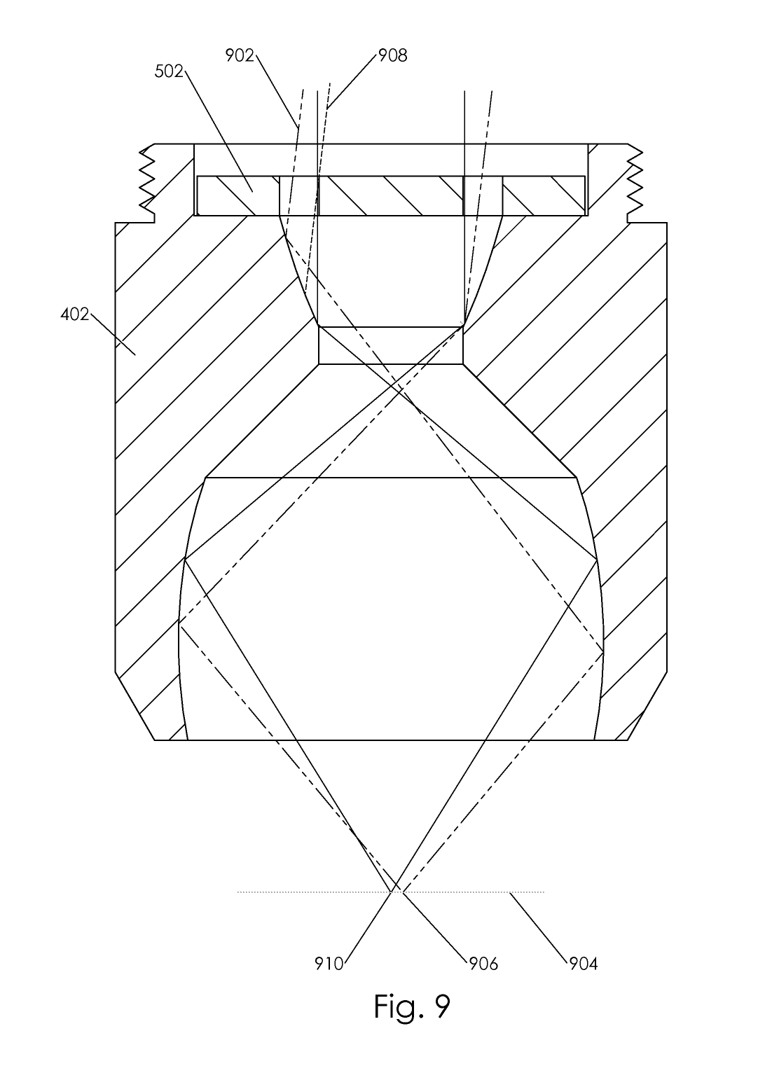

FIG. 9 shows a cross-sectional view of the objective of FIG. 5 including mask 502, according to an example embodiment. FIG. 9 illustrates an inefficiency of a single mask. As shown in FIG. 9, an off-axis light ray 902 is received that passes between the central obscuration and ring shaped portion of mask 502 to interact with first concave mirrored surface 404. Off-axis light ray 902 reflects off of first concave mirrored surface 404 and then off of second concave mirrored surface 406 to pass through the objective and be received at a reflective sample plane/surface 904 at an off-axis focal point 906 (which is a different location from an on-axis focal point 910 corresponding to focus point 116 of FIG. 1). For instance, in order to block on-axis light rays (light rays that are parallel to the axis of symmetry of the objective), mask 502 may have a diameter that is at least the diameter of the first opening hole in first concave mirrored surface 404. First concave mirrored surface 404 is not fully illuminated by light rays entering at an angle.

In an embodiment, an objective may be configured to enable adjustment of the relative positions of first and second concave mirrored surfaces 404 and 406. For instance, in one embodiment, the objective may include an optional element that enables the concave mirrored surfaces 404 and 406 to move relative to each other perpendicular to the axis of symmetry, allowing for axial alignment between concave mirrored surfaces 404 and 406. In another embodiment, the objective may include an optional element that enables the two surfaces to be moved closer together or further apart alone the axis of symmetry, enabling the adjustment of spherical aberration. In one situation, this may compensate for the aberration induced by the thickness of an optically clear window used to support, hold, or sandwich a microscope sample.

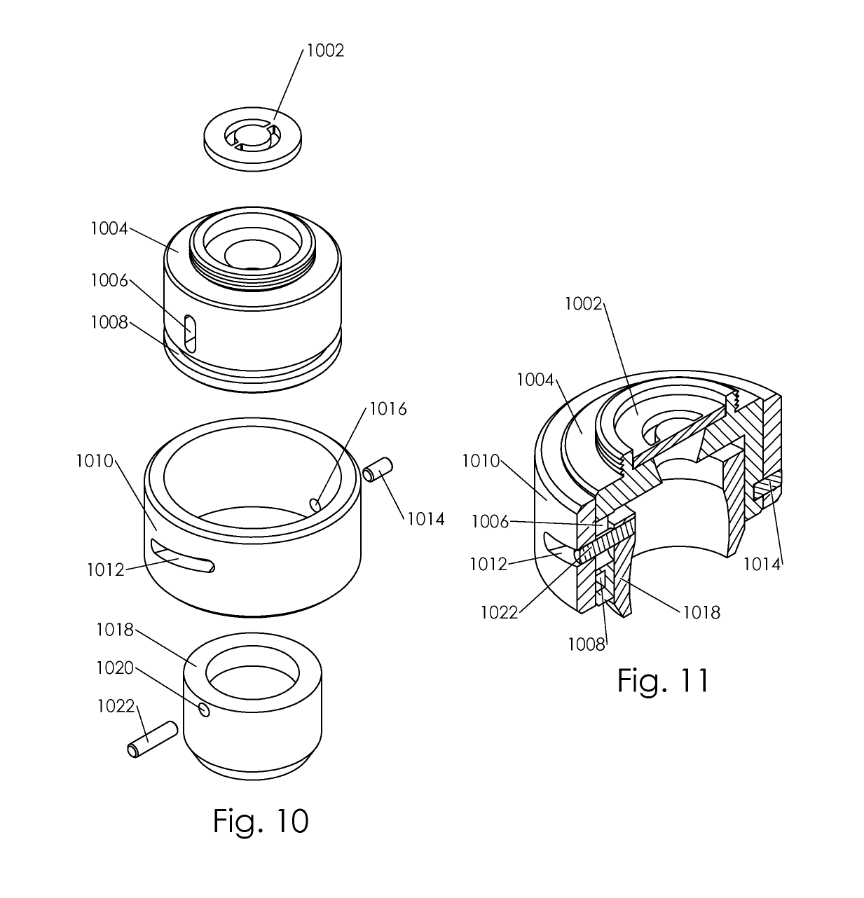

For instance, FIG. 10 shows an exploded view of an objective that includes the first and second concave mirrored surfaces shown in FIG. 4, and includes a mechanism for adjusting spacing between concave mirrored surfaces 404 and 406 (along an axis of symmetry, such as axis 116 of FIG. 1), according to an example embodiment. Such a mechanism may be helpful to relieve manufacturing errors. It also enables the user to add spherical aberration to compensate for the spherical aberration created by rays passing through a window.

As shown in FIG. 10, the objective includes a mask 1002, a first (e.g., upper) housing 1004 that internally contains first concave mirrored surface 404, a vertical slot 1006 in first housing 1004, a groove 1008 in first housing 1004, an adjustment ring 1010, an angled slot 1012 in adjustment ring 1010, a first pin 1014, a hole 1016 in adjustment ring 1010, a second (e.g., lower) housing 1018, a hole 1020 in second housing 1018, and a second pin 1022. As shown in FIG. 10, first housing 1004 is cylindrical and includes vertical slot 1006 extending through the cylindrical wall of first housing 1004, and groove 1008 extends around first housing 1004 adjacent to the edge (e.g. bottom edge in FIG. 10) of first housing 1004. Adjustment ring 1010 is cylindrical, and angled slot 1012 and hole 1016 each extend through the cylindrical wall of adjustment ring 1010. Second housing 1018 is cylindrical, and hole 1020 extends through the cylindrical wall of second housing 1018.

FIG. 11 shows a cut away perspective view of the objective of FIG. 10 assembled together, according to an example embodiment. As shown in FIG. 11, second housing 1018 may be positioned in first housing 1004. Furthermore, adjustment ring 1010 fits around first housing 1004, such that second pin 1022 may be inserted to extend through angled slot 1012, vertical slot 1006, and hole 1020. Furthermore, first pin 1014 may be inserted to extend through hole 1016 into groove 1008 in first housing 1004.

As such, when adjustment ring 1010 is rotated around first housing 1004, pin 1022 transfers the rotary motion of adjustment ring 1010 into linear (axial) motion of second housing 1018. Such motion enables second housing 1018 to be movable relative to first housing 1004 along the axis of symmetry of the objective body to enable adjustment of spherical aberration of the objective. Pin 1022 can slide in slot 1006 during rotation of adjustment 1010 to prevent lower housing 1018 from rotating while allowing the axial movement. Pin 1022 in groove 1008 prevents axial movement of adjustment ring 1010 relative to first housing 1004 while allowing the rotary motion of adjustment ring 1010. Pin 1014 is in contact with groove 1008 to prevent axial movement of adjustment ring 1010 relative to first housing 1004 while allowing rotary motion. Thus, by twisting/rotating adjustment ring 1010 around the axis of symmetry of the objective, adjustment ring 1010 rotates around first housing 1004, and second housing 1018 is moved along the axis of symmetry of the objective relative to adjustment ring 1010 and first housing 1004. Second housing 1018 moves a distance corresponding to the amount that adjustment ring 1010 is rotated around first housing 1004.

Furthermore, in an embodiment, second housing 1018 may be configured to be movable relative to first housing 1004 perpendicularly to the axis of symmetry of the objective to enable axial alignment of first and second concave mirrored surfaces 404 and 406. For instance, in one example, one or more pins through holes in first housing 1004 may be provided that may hold second housing 1018 in place within first housing 1004. The pins may be moveable (e.g., by a screwing motion, etc.) in and out of their respective holes in the sides of first housing 1004 to move second housing 1018 laterally with respect to first housing 1004, thereby moving second housing perpendicularly to the axis of symmetry of the objective, and enabling axial alignment of first and second concave mirrored surfaces 404 and 406. In embodiments, various other mechanism of FIGS. 10 and 11 may be used to enable axial and/or lateral adjustment first and second concave mirrored surfaces 404 and 406, including a threaded adjustment ring rather than the adjustment ring with a slot shown in FIGS. 10 and 11, and further types of mechanisms as would be apparent to persons skilled in the relevant art(s) from the teachings herein.

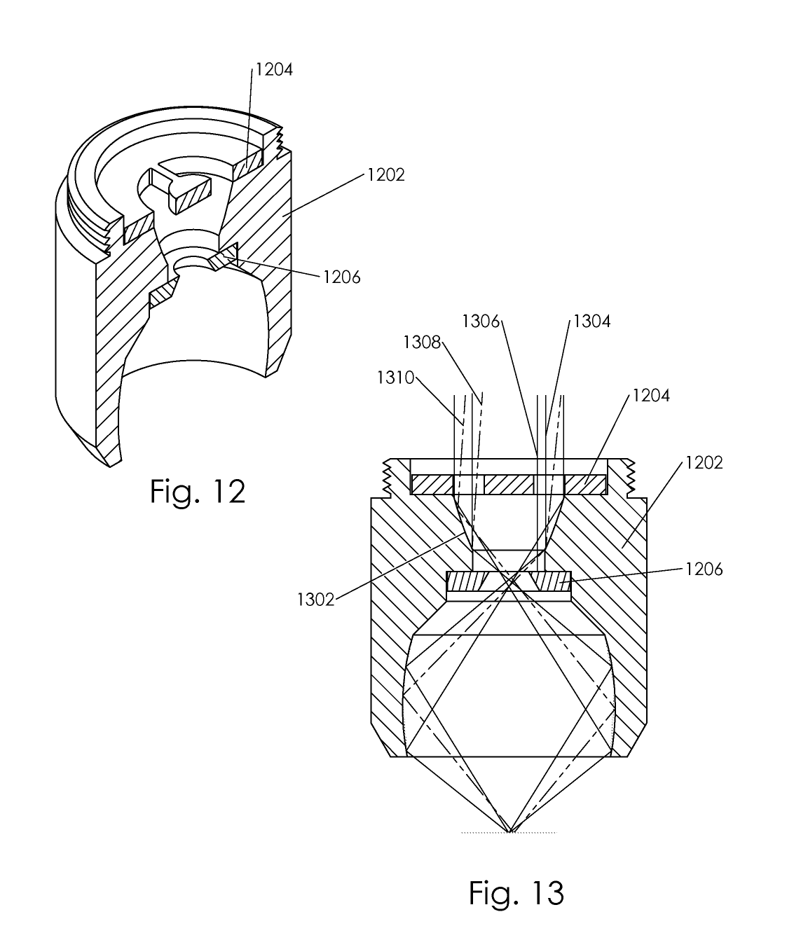

As described above, a mask used to filter light through an objective may have a single piece. In further embodiments, a mask used to filter light through an objective may have multiple pieces. Examples of types of two-element masks are shown in FIGS. 12-16. For instance, FIG. 12 shows a cut away perspective view of an objective that uses a two-element mask, according to an example embodiment. As shown in FIG. 12, the objective includes a body 1202 that is generally similar to body 402 of the objective of FIG. 4, and further includes a first mask portion 1204 (also referred to as a “first sub-mask” or a “first mask element”) and a second mask portion 1206 (also referred to as a “second sub-mask” or a “second mask element”).

First mask portion 1204 has a central obscuration positioned on the axis of symmetry of body 1202 and is positioned at the first end of body 1202. First mask portion 1204 is positioned inside a cylindrical portion of body 1202 extending from the first end of body 402 (similar to the placement of mask 502 in FIG. 5). In the embodiment of FIG. 12, the cylindrical portion has smooth inner walls, and is threaded around its perimeter (e.g., to enable the objective to be screwed into a mating optical system component). First mask portion 1204 includes a central obscuration that blocks light from passing through a center of first mask portion 1204, providing a portion of the masking function, while enabling light to pass through first mask portion 1204 around the central obscuration. First mask portion 1204 may be configured in various ways, in embodiments, including as shown for masks 602, 604, and 606 of FIGS. 6A-6C. Note that the first mask portion 1204 can be substantially smaller than mask 502 shown in FIG. 5 and mask 802 shown in FIG. 8 because the two mask elements of FIG. 12 can be configured to block stray light rays together similarly to (e.g., equal to, less than, or greater than) a single mask.

Second mask portion 1206 is separate from first mask portion 1204, and has an annular obscuration positioned in a channel in body 1202 between the first opening and the second opening of first and second concave mirrored surfaces 404 and 406. The annular obscuration obscures light in a perimeter ring shaped area, but allows light to pass through a central region (e.g., in an opposite fashion to a central obscuration). As shown in the embodiment of FIG. 4, first and second concave mirrored surfaces 404 and 406 are coupled together by a cylindrical channel. In the embodiment of FIG. 12, first and second concave mirrored surfaces 404 and 406 are coupled together by a cylindrical channel that includes a first cylindrical channel portion (also referred to as a “first sub-channel”) adjacent to the first opening of first concave mirrored surface 404, and a second cylindrical channel portion (also referred to as a “second sub-channel”) between the first cylindrical channel portion and the second opening of second concave mirrored surface 404. The second cylindrical channel portion has a diameter that is greater than the diameter of the first cylindrical channel portion. Second mask portion 1206 is positioned in the second cylindrical channel portion. Second mask portion 1206 is generally ring shaped (e.g., similar to a washer) having an outer ring with a central opening. The inner edges of the outer ring extend inwardly from the walls of the second cylindrical portion further than the rim of the first cylindrical portion, and provide an annular obscuration to light passing through the central pathway of the objective.

Note that in one embodiment, the inner edge of the outer ring may be perpendicular to the top and bottom surfaces of the outer ring. In another embodiment, as shown in FIG. 12, the inner edge of the outer ring may be not be perpendicular to the top and bottom surfaces of the outer ring, and instead may be angled (an angle that is not 90 degrees, acute or obtuse) with regard to the top surface. An acute angle with respect to the top surface of the outer ring, as shown in FIG. 12, may be used to enable additional light rays to travel through the central opening of second mask portion 1206 without being blocked.

For instance, FIG. 13 shows a cross-sectional view of the objective of FIG. 12 including the two-element mask, according to an example embodiment. FIG. 13 illustrates examples of light rays that pass through the objective or are filtered by the two-element mask. In FIG. 13, first concave mirrored surface 404 is indicated as first concave mirrored surface 1302. A first ray 1304 parallel to the axis of symmetry is shown being received at the first end of the objective. Light ray 1304 passes through first mask portion 1204, does not interact with first concave mirrored surface 1302, and is blocked (filtered) by second mask portion 1206. A second light ray 1306 parallel to the axis of symmetry is shown being received at the first end of the objective. Light ray 1306 passes through first mask portion 1204, does not interact with first concave mirrored surface 1302, and is blocked (filtered) by second mask portion 1206. A first off-axis light ray 1308 is shown being received at the first end of the objective. Off-axis light ray 1308 passes through first mask portion 1204, interacts with first concave mirrored surface 1302, and shows that all of first concave mirror surface 1302 is illuminated. A second off-axis light ray 1310 is shown being received at the first end of the objective. Off-axis light ray 1310 passes through first mask portion 1204, interacts with first concave mirrored surface 1302, and passes through to the focal plane near the focal point of the objective without interacting with second mask portion 1206. Additional light rays parallel to the axis of symmetry (collimated light rays) received by the objective are shown that passes through first mask portion 1204, interact with first concave mirrored surface 1302, pass through second mask portion 1206, interact with the second concave mirrored surface, and are thereby focused to the focal point in the focal plane of the objective, as desired.

As described above, any number of arms may be used in first mask portion 1204 to support the central obscuration, including one or more arms. Two arms may provide better support that one arm. Furthermore, two arms still appear as two arms in the aperture plane upon reflection from the sample, but three arms appear to become 6 arms. As such, two arms may be optimal for support and limiting the obscured area in some embodiments, although in other embodiments, other numbers of arms may be used.

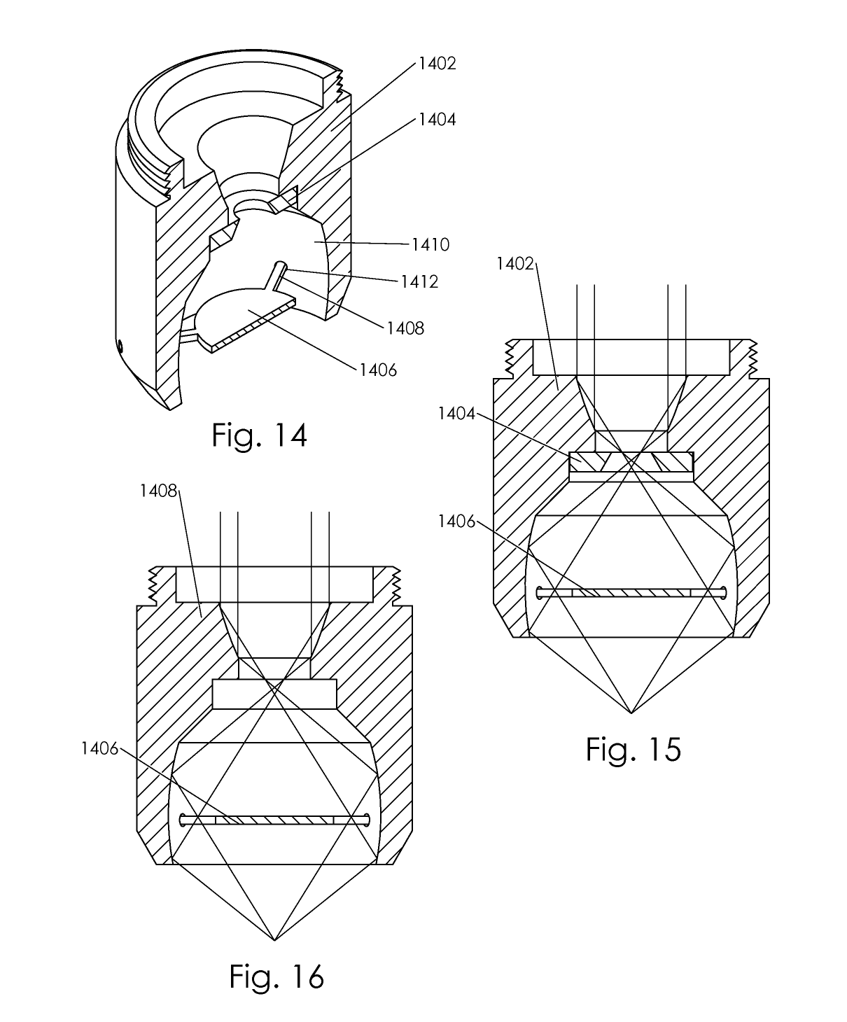

FIG. 14 shows a cut away perspective view of an objective that uses another type of two-element mask, according to an example embodiment. As shown in FIG. 14, the objective includes a body 1402 that is generally similar to body 1202 of the objective of FIG. 12, and further includes a first mask portion 1404 (also referred to as a “first sub-mask” or a “first mask element”) and a second mask portion 1406 (also referred to as a “second sub-mask” or a “second mask element”). As shown in FIG. 14, the objective further includes first and second concave mirrored surfaces 404 and 406 (labeled as 1410 in FIG. 14).

First mask portion 1404 is shaped the same and positioned similarly to second mask portion 1206 of FIG. 12, providing an annular obscuration in the channel in body 1402 (e.g., the second cylindrical channel portion) between the first opening and the second opening of first and second concave mirrored surfaces 404 and 1410.

Second mask portion 1406 is separate from the first mask portion 1404, and includes a central obscuration 1406 positioned on the axis of symmetry of body 1402 between the channel and the second end of body 1402 (e.g., within a space formed within second concave mirror surface 1410). Central obscuration 1406 is held in position by at least one arm 1408 (two arms are shown in FIG. 14; a third arm is not visible) extending through a hole 1412 in second concave mirrored surface 1410.

In an embodiment, the arms (e.g., arm 1408) may be flexed and then allowed to expand into place, to hold second mask portion 1406 in position. For instance, second mask portion 1406 may be made of a thin piece of spring steel that enables the arm(s) 1408 to flex before being extended through hole(s) 1412 and to return to an un-flexed shape after being extended through hole(s) 1412. In another embodiment the arms of second mask portion 1406 may be angled and attached to the second end of body 1402.

The position of second mask portion 1406 enables greater blocking of stray light rays while lessening a need to position the mask as accurately, relative to the two-element mask of FIG. 12 and the single element mask of FIG. 9. For instance, FIG. 15 shows a cross-sectional view of the objective of FIG. 14 with first and second concave mirror surfaces 404 and 1410, and showing light rays passing there through, according to an example embodiment. In an embodiment, first mask portion 1404 may be removed/not used, leaving second mask portion 1406 as a single element mask to block stray light rays, although maintaining both first and second mask portions 1404 and 1406 may be desired to enable a wider range of angles of stray light rays to be filtered than having second mask portion 1406 alone. For instance, FIG. 16 shows a cross-sectional view of the objective of FIGS. 14 and 15 with second mask portion 1406 present (first mask portion 1404 is not present), and showing light rays passing through the objective, according to an example embodiment.

First and second mask portions 1204 and 1206, mask 804, mask 810, mask 1002, and first and second mask portions 1404 and 1406 may each be made from one or more metals (e.g., an alloy) such as iron, steel (e.g., stainless steel, spring steel), sheet metal, aluminum, copper, brass, glass, a polymer, etc. A mask may include a first mask portion made from a substantially optically clear window with a substantially opaque obscuration, eliminating the need for support arms for the obscured area.

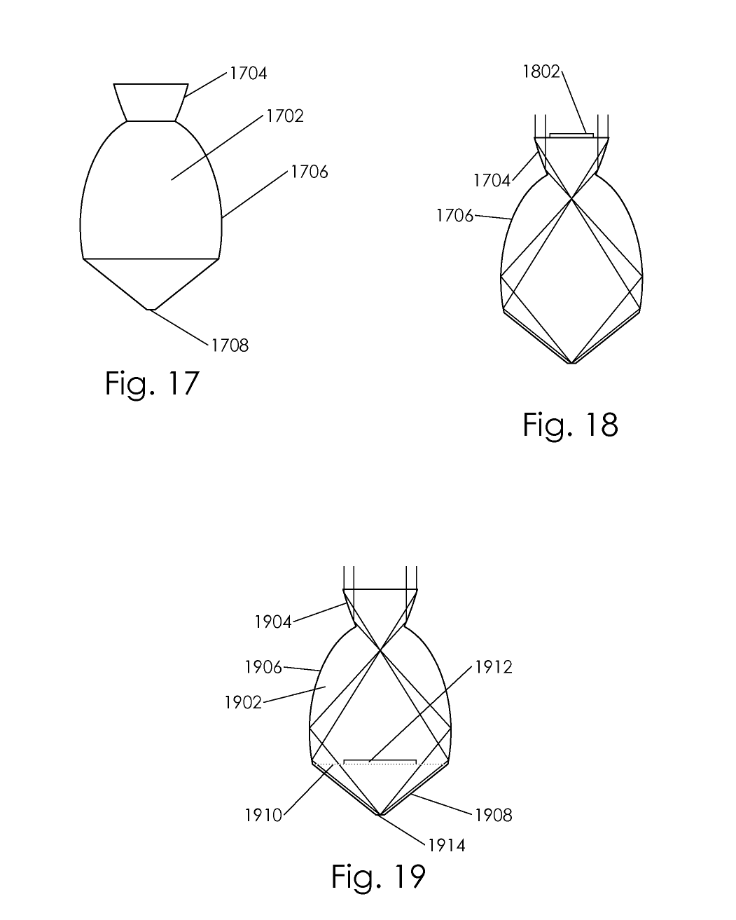

In embodiments, such as those described above with respect to FIGS. 4-16, objectives that have a solid body surrounding an interior space through which light passes are provided. In further embodiments, objectives that have a transparent solid body through which the light passes are provided. For instance, FIG. 17 shows a side cross-sectional view of a solid optically clear objective, according to an example embodiment. In the embodiment of FIG. 17, first and second concave mirrored surfaces 404 and 406 defined by the disclosed equations are formed on a substantially optically clear material, and light rays traveled inside of the material of the objective.

As shown in FIG. 17, the objective includes a body 1702, a first surface 1704, a second surface 1706, and an apex 1708. Body 1702 is made of a transparent, optically clear material, such as glass, a transparent polymer, a transparent epoxy, a crystal, etc. Body 1702 is shaped in an hourglass shape, similar to the interior of the objective of FIG. 4. Body 1702 has a first (e.g., upper) portion that has first surface 1704 as a surrounding perimeter surface, has a second (e.g., middle portion) that has second surface 1706 has a perimeter surface, and a third (e.g., bottom portion) that has apex 1708 at a tip (at the second end of the objective, at the focal plane). The first portion of body 1702 has a flat surface at which light may be received by and/or transmitted from the objective, depending on the particular application. First surface 1704 is shaped according to the corresponding equations (e.g., Equations 2020, 2022, 2024) described above, and therefore may have first concave mirror surface 404 formed thereon. Second surface 1706 is shaped according to the corresponding equations (e.g., Equations 2026, 2028) described above, and therefore may have second concave mirror surface 406 formed thereon. The third portion of the objective is conical shaped, with the wide end of the cone coupled to the second portion of the objective, and the pointed end of the third portion, which may or may not be flattened, is where apex 1708 is located. Subjects to be sampled (e.g., viewed) may be positioned adjacent to apex 1708, which is the focal point for the objective. In an embodiment, apex 1708 of the objective reflects light rays that enter the first portion (and pass through the second and third portions of the objective) by total internal reflection, which allows for Attenuated Total Reflection (ATR) sampling.

FIG. 18 shows the side cross-sectional view of the objective of FIG. 17, with light rays traveling through the objective, according to an example embodiment. As shown in FIG. 18, collimated light rays may enter the flat surface of the first portion of the objective, may pass through the first portion of the objective, reflecting off of first concave mirror surface 404 into the second portion of the objective, and reflecting off of second concave mirror surface 406 through the second portion into the third portion of the objective to apex 1708. The light may reflect from apex 1708 back through the second portion, to be reflected from the second concave mirror surface 406 to the first portion of the objective, to be reflected from the first concave mirror surface 404 to collimated and transmitted from the flat surface at the first end of the objective.

In embodiments, a mask may be used with the objective of FIG. 17 to filter light rays. For instance, in an embodiment, as shown in FIG. 18, a mask 1802 may be positioned on the flat surface at the first end of the objective to filter some light rays (e.g., collimated light rays close to the axis of symmetry and/or off-axis light rays) from entering the objective in a similar fashion as mask 502 of FIG. 5. For instance, mask 1802 may be a circular or disk-shaped obscuration (no arms or outer ring shaped portion needed to be present), or may have other shape, and may be made of a metal, an opaque polymer, an opaque filling, and/or other material disclosed herein or otherwise known. In another embodiment, surfaces 1704 and 1706 may not be mirrored, but may rely on the light rays reflecting by total internal reflection. If the angle with which the light ray strikes the surface is greater than the critical angle for the material the body is made from, the ray will reflect off of the surface with close to 100% efficiency.

In another example of a transparent objective with a mask, a two-piece transparent object may be used to include a mask in the transparent objective interior. For instance, FIG. 19 shows a side cross-sectional view of a two-piece transparent objective, with a mask between the two pieces and with light rays traveling through the objective, according to an example embodiment. The objective has a body, a first surface 1904, a second surface 1906, and an apex 1914. The objective of FIG. 19 is similar to the objective of FIG. 17, having first-third portions, with first surface 1904 of the first portion shaped according to the corresponding equations described above, second surface 1906 of the second portion shaped according to the corresponding equations described above, and a conical third portion having apex 1914 at a tip (adjacent to a focal point in a focal plane/sample area). However, the body is separated into two pieces. The first and second portions form a first piece 1906 of body 1902, and the third portion forms a second piece 1908 of body 1902. First and second pieces 1906 and 1908 are made of a transparent material, as described elsewhere herein or otherwise known. A flat interface 1910 is present between the second portion and the third portion where surfaces of the first and second pieces may be coupled together.

Furthermore, a mask 1912 may be formed in the objective, as shown in FIG. 19.

Mask 1912 is positioned between the first and second pieces at flat interface 1910. For instance, a depression may be formed in the surface of the first piece and/or the second piece at flat interface 1910 in which mask 1912 may reside. Mask 1912 may is positioned to filter some light rays passing through body 1902 in a similar fashion as second mask portion 1406 of FIGS. 14-16. For instance, mask 1912 may be a circular or disk-shaped obscuration (no arms or outer ring shaped portion needed to be present), or may have other shape, and may be made of a metal, an opaque polymer, an opaque filling, and/or other material disclosed herein or otherwise known.

As such, various embodiments for objectives, including single piece objectives, multi-piece objectives, hollow objectives, transparent objectives, adjustable objectives, and objectives with or without masks. Such objectives may be used in various applications to provide for focusing, magnifying, and filtering of light.

For instance, Attenuated Total Reflection (ATR) is a spectroscopic technique that requires the light rays to reflect off of an interface between two materials at an angle greater than the critical angle. In an embodiment, a low cost, monolithic ATR microscope objective could be made using the equations described herein rather than the spherically approximated microscope objective available today. Both ends of the objective may be flat, and as the input beam would be collimated the flat ends would not add spherical or coma. Distortion may increase, as well as chromatic aberration, but this should be minimal due to the small maximum input angle.

In an embodiment, a dome shaped ATR crystal may be placed at the focus to achieve ATR microscopy as well. The dome may be part of the objective, or may be removable to allow a two mode objective (e.g., a normal mode and an ATR mode).

In an embodiment, a microscope system that includes three identically configured objectives (used as objective, condenser, and detector optics) using symmetry may minimize optical aberrations.

Embodiments of objectives may be used in space born application, as the objectives do not change due to vibration. This is an advantage in a high-vibration environment, such as in military analytical instrumentation on the battlefield.

In an embodiment, a “grazing angle” microscope objective can be formed by making the aperture large enough that the light rays form a maximum angle of 85 degrees with the sample.

A larger entrance aperture leads to more energy through the objective. This may be important to scientists who measure chemical composition using an FTIR (Fourier transform infrared spectroscopy) microscope because more throughput enables a higher signal to noise ratio, and a higher signal to noise ratio enables smaller chemical quantities to be detected.

Embodiments enable a narrower microscope objective, which enables more objectives to fit on a rotary turret.

Embodiments enable a monolithic design, which enables objectives to be more rugged, durable, and less likely to fall out of an aligned state.

A monolithic design also enables improved thermal stability because the entire objective may be made of one material rather than multiple materials (glass-aluminum or steel-brass), which may have different coefficients of thermal expansion (CTE).

In embodiments, masks may be used to block out light rays that would otherwise hit the reflective sample surface and bounce back or would transmit through both objectives in an objective/condenser pair. An example of such a mask embodiment is an annular mask between the first and second concave mirror surfaces, and a smaller round mask in front of it (e.g., as shown in FIGS. 12 and 13). Such a mask provides a maximum blocking of stray light rays while reducing vignetting at field angles greater than 0 degrees.

An example advantage of embodiments is that a relatively large amount of energy that can be transferred through the objectives when compared to a comparable spherically approximated Schwarzschild objective.

Another example advantage is that some objective embodiments may be manufactured from a single piece of material. This provides a cost savings because current conventional implementations require alignment of the primary and secondary mirrors, which is a labor intensive process. In embodiments where both the primary and secondary mirrors are part of the same element, there is no need to align them relative to each other.

Another example advantage is that monolithic fabrication enables a more robust objective that is capable of withstanding greater vibratory forces that a traditional Schwarzschild design.

Furthermore, computerized light ray tracing and optimization is enabled because the surface slopes and normal vectors can be calculated precisely, unlike in the numerical techniques. The second derivative may be taken, which yields the instantaneous curvature of the concave mirror surface at that point in space. A numerical method requires two calculated points to determine the slope, and requires three calculated points to determine the curvature. Because each point is itself an approximation and the slope obtained would also be an approximation, the use of the shown parametric equations provides a great advantage. The advantage extends beyond specifying the surface accurately: It increases the accuracy of any optical models used in the design process which require accurate slopes, normals, and curvatures.

Still further, in embodiments, because the profile of the objective is narrower than that of traditional reflecting objectives, more objectives can fit on a nosepiece turret. Currently only two of the traditional objectives fit on a turret, with any more causing interference between the outer diameters.

The equations disclosed herein to determine the shape of the first and second concave mirrored surfaces give exact values for the points that define their surfaces. The other techniques that are available are either approximations that are not as accurate or use standard conic surfaces that do not correct for coma except in certain limited cases. By using the equations disclosed herein, not only can the points of the concave mirror surfaces be determined accurately, but also the slopes and normals to those points, which enables accurate trace light rays to be generated.

In some cases, the two-element mask of FIG. 12 may be better than the one stage mask (of FIG. 5) at blocking stray light rays from traveling through the objective because all of concave mirror surface 404 is enabled to be used. When a single element mask is used, the mask may be made larger because light rays entering the objective at an angle should be blocked. As such, the mask should be larger than the first opening in the first concave mirror surface. The first mask portion for the two-element mask can be substantially smaller than the first opening in first concave mirror surface 404, and therefore block out fewer of the usable light rays.

The two-element mask of FIG. 14 has an advantage of better stray light blocking while at the same time allowing for less accurate placement. It also helps to protect the inner surface of the objective.

The single element mask of FIG. 16 enables adequate blocking of stray light rays by placing a centrally obscured mask after first concave mirror surface 404.

By separating the first and second concave mirror surfaces 404 and 406 is different pieces of an objective (e.g., as in FIGS. 10 and 11), compensation for the blurring of the image created when the microscope sample is placed on or sandwiched between two optically clear windows is enabled. The ability to eliminate this blurring by adding an amount of spherical aberration equal and opposite to the spherical aberration induced by the window is a substantial advantage over a fixed system.

### Conclusion

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. An objective, comprising:
a body;
a first concave mirrored surface on the body having a centrally located first opening, a shape of the first concave mirrored surface defined by at least one equation;
a second concave mirrored surface on the body having a centrally located second opening, a shape of the second concave mirrored surface defined by at least one equation, the first and second concave mirrored surfaces oriented in opposition to each other and coupled together at the first and second openings;
a central pathway extending from a first end of the body opposite the first concave mirrored surface to a second end of the body opposite the second concave mirrored surface, an axis of symmetry of the body residing in the central pathway, the first concave mirrored surface and the second concave mirrored surface focusing light passing through the central pathway through the body; and
a mask that at least partially obscures the light passing through the central pathway through the body.

2. The objective of claim 1, wherein the mask comprises:
a first mask portion having a central obscuration positioned on the axis of symmetry of the body and positioned at the first end of the body; and
a second mask portion separate from the first mask portion having an annular obscuration positioned in a channel in the body between the first opening and the second opening.

3. The objective of claim 2, wherein first mask portion further comprises:
a ring shaped portion that is separate from and rings the central obscuration; and
at least one arm connected between the ring shaped portion and the central obscuration.

4. The objective of claim 2, wherein first mask portion further comprises:
a substantially optically clear ring shaped portion that rings and supports the central obscuration in position on the axis of symmetry.

5. The objective of claim 1, wherein the mask comprises:
a first mask portion having an annular obscuration positioned in a channel in the body between the first opening and the second opening; and
a second mask portion separate from the first mask portion having a central obscuration positioned on the axis of symmetry of the body between the channel and the second end of the body, the central obscuration held in position by at least one arm extending through a hole in the second concave mirrored surface.

6. The objective of claim 5, wherein the second mask portion is made of a thin piece of spring steel that enables at least one arm to flex before being extended through the hole and to return to an un-flexed shape after being extended through the hole.

7. The objective of claim 5, wherein the second mask portion comprises a disk having at least one threaded hole in an outer edge of the disk, and wherein the at least one arm is a threaded rod that mates with the at least one threaded hole.

8. The objective of claim 5, wherein the second mask portion comprises a disk that is attached to the at least one arm by an adhesive material.

9. The objective of claim 5, wherein the second mask portion comprises a disk that is attached to the at least one arm by a solder.

10. The objective of claim 5, wherein the second mask portion comprises a disk, wherein the at least one arm is a wire that is attached to the disk by an adhesive material.

11. The objective of claim 5, wherein the second mask portion comprises a disk, wherein the at least one arm is a wire that is attached to the disk by a solder.

12. The objective of claim 5, wherein the at least one arm is angled and attached to the second end of the body.

13. The objective of claim 1, wherein the mask includes an annular mask machined into the body.

14. The objective of claim 1, wherein the mask comprises:
a central obscuration positioned on the axis of symmetry of the body between the second opening and the second end of the body, the central obscuration held in position by at least one arm extending through a hole in the second concave mirrored surface.

15. The objective of claim 1, wherein the mask comprises:
a central obscuration positioned on the axis of symmetry of the body between the second opening and the second end of the body, the central obscuration held in position by at least one arm attached to the second end of the body.

16. The objective of claim 1, wherein the body comprises:
a first housing having a surface on which the first concave mirrored surface resides; and
a second housing having a surface on which the second concave mirrored surface resides, the second housing configured to be movable relative to the first housing perpendicularly to the axis of symmetry of the body to enable axial alignment of the first and second concave mirrored surfaces.

17. The objective of claim 1, wherein the body comprises:
a first housing having a surface on which the first concave mirrored surface resides; and
a second housing having a surface on which the second concave mirrored surface resides, the second housing configured to be movable relative to the first housing along the axis of symmetry of the body to enable adjustment of spherical aberration of the objective.

18. The objective of claim 1, wherein the body comprises:
a substantially optically clear material that substantially fills a space between the first and second concave mirrored surfaces;
wherein the central pathway passes through the substantially optically clear material, and the first and second concave mirrored surfaces are formed on a surface of the substantially optically clear material.

19. The objective of claim 18, wherein the substantially optically clear material comprises:
a first portion of substantially optically clear material; and
a second portion of substantially optically clear material;
wherein the mask is held in place between the first portion and the second portion.

20. A method, comprising:
forming a first concave mirrored surface on a body to have a centrally located first opening, a shape of the first concave mirrored surface defined by at least one equation;
forming a second concave mirrored surface on the body to have a centrally located second opening, a shape of the second concave mirrored surface defined by at least one equation, the first and second concave mirrored surfaces oriented in opposition to each other and coupled together at the first and second openings;
positioning a mask to at least partially obscure light passing through a central pathway through the body that extends from a first end of the body opposite the first concave mirrored surface to a second end of the body opposite the second concave mirrored surface, an axis of symmetry of the body residing in the central pathway;
receiving an input light at the first end of the body; and
focusing the input light with the first concave mirrored surface and the second concave mirrored surface as the input light passes through the central pathway through the body to generated focused light transmitted from the second end of the body.
